(19) United States
(12) Patent Application Publication
(10) Pub. No.: US 2019/0279583 A1
(43) Pub. Date: Sep. 12, 2019

(54) PIXEL CHARGING COMPENSATION METHOD AND DEVICE, DETECTING METHOD AND DEVICE

(71) Applicant: BOE Technology Group Co., Ltd., Beijing (CN)

(72) Inventors: Guangliang Shang, Beijing (CN); Yaoqiu Jing, Beijing (CN); Yifang Chu, Beijing (CN); Xue Dong, Beijing (CN)

(73) Assignee: BOE Technology Group Co., Ltd., Beijing (CN)

(21) Appl. No.: 16/340,508

(22) PCT Filed: Aug. 23, 2018
(86) PCT No.: PCT/CN2018/101895

§ 371 Date: May 30, 2019

(30) Foreign Application Priority Data
Aug. 31, 2017 (CN) 201710772543.9

(51) Int. Cl. G09G 3/36

(52) U.S. Cl. CPC G09G 3/3611; G09G 2310/08; G09G 2320/0233; G09G 2320/029

(57) ABSTRACT

A method and a device for detecting pixel charging compensation, and a method and a device for compensating pixel charging are provided. The method for detecting includes: dividing a display area of a display panel into at least two compensation regions; detecting a first brightness of a target pixel in each compensation region; and calculating a compensation time duration for charging the target pixel according to a difference between the first brightness and the set brightness; and setting the compensation time duration to be a compensation time duration for charging the pixels in the compensation region in which the target pixel is located.

### CROSS-REFERENCE TO RELATED APPLICATION

The present application is a U.S. national phase application of PCT Application No. PCT/CN2018/101895 filed on Aug. 23, 2018, which published as as WO 2019/042212 A1 on Mar. 7, 2019, and claims priority to Chinese patent application No. 201710772543.9, filed in China on Aug. 31, 2017, the disclosures of which are incorporated herein by reference in their entireties.

### TECHNICAL FIELD

The present disclosure relates to the field of display technology, and in particular, to a method for detecting pixel charging compensation, a device for detecting pixel charging compensation, a method for compensating pixel charging, and a device for compensating pixel charging.

### BACKGROUND

Due to a low power consumption, a low cost, no radiation and easy operation of a liquid crystal display (LCD), the LCD has been increasingly used in people's life and work and is widely used in various fields, such as homes and public sites, offices, personal electronic products, etc.

### SUMMARY

A method for detecting pixel charging compensation, a device for detecting pixel charging compensation, a method for compensating pixel charge, and a device for compensating pixel charging are provided in the present disclosure.

In a first aspect, the method for detecting pixel charging compensation is provided in the present disclosure and includes: dividing a display area of a display panel into at least two compensation regions according to an arrangement direction of a plurality of scan lines, wherein each of the at least two compensation regions includes a plurality of pixels connected to at least one of the plurality of scan lines; detecting a first brightness of each target pixel of one or more target pixels in each of the plurality of compensation regions within a set charging time duration when the display panel displays a set detection image; obtaining a difference between the first brightness and a set brightness of the target pixel; calculating a compensation time duration for charging the target pixel based on the difference; and setting the compensation time duration to be a compensation time duration for charging pixels in the compensation region in which the target pixel is located.

In some embodiments, the detecting the first brightness of the each target pixel of the one or more target pixels in each of the plurality of compensation regions within the set charging time duration when the display panel displays the set detection image, includes: determining one or more key positions in each of the plurality of compensation regions when the display panel displays the set detection image; and detecting the first brightness of the target pixel at each of the one or more key locations within the set charging time duration.

In some embodiments, after calculating the compensation time duration for charging the target pixel based on the difference, the method further includes: calculating a target charging time duration for the target pixel by using the set charging time duration and the compensation time duration; and determining the target charging time duration for the target pixel to be the charging time duration for charging all pixels in the compensation region in which the target pixel is located.

In some embodiments, the calculating the target charging time duration for the target pixel by using the set charging time duration and the compensation time duration, includes: in a case that the first brightness is greater than the set brightness, the target charging time duration for the target pixel is the set charging time duration of the target pixel minus the compensation time duration for the target pixel; and in a case that the first brightness is less than the set brightness, the target charging time duration for the target pixel is the set charging time duration for the target pixel plus the compensation time duration for the target pixel.

In some embodiments, a difference between a total time duration for charging pixels in all compensation regions before compensation is performed and a total time duration for charging the pixels in the all compensation regions after the compensation performed is less than a set threshold.

Optionally, the one or more target pixels are pixels located at in-between positions of the compensation region, or pixels for which a charging time duration is between a longest set charging time duration and a shortest set charging time duration in the compensation region.

Optionally, a quantity of the target pixels is two or more than two, and the compensation time duration for charging the pixels in each of the plurality of compensation regions is an average value of compensation time durations calculated according to differences of the two or more than two target pixels.

In some embodiments, the first brightness is a brightness when the display panel displays the detection image and a charging process for the target pixel is finished.

In a second aspect, the method for compensating pixel charging is provided and includes: performing charging compensation to pixels in a compensation region based on a compensation time duration for charging the pixels in the compensation region, wherein the compensation time duration is determined according to the method in the first aspect.

In a third aspect, the device for detecting pixel charging compensation is provided and includes a dividing module, configured to divide a display area of a display panel into at least two compensation regions according to an arrangement direction of a plurality of scan lines, wherein each of the plurality of compensation regions includes a plurality of pixels connected to at least one of the plurality of scan lines; a detecting module, configured to detect a first brightness of each of one or more target pixels in each of the plurality of compensation regions within a set charging time duration when the display panel displays the set detection image; an obtaining module, configured to obtain a difference between the first brightness and a set brightness of the target pixel; a first calculating module, configured to calculate a compensation time duration for charging the target pixel based on the difference; and a setting module, configured to set the compensation time duration to be a compensation time duration for charging pixels in the compensation region in which the target pixel is located.

In some embodiments, the detecting module includes: a determining unit, configured to determine one or more key positions in each of the plurality of compensation regions when the display panel displays the set detection image; and a detecting unit, configured to detect the first brightness of the target pixel at each of the one or more key positions within the set charging time duration.

In some embodiments, the device for detecting pixel charging compensation further includes: a second calculating module, configured to calculate a target charging time duration for the target pixel by using the set charging time duration and the compensation time duration; and a determining module, configured to determine the target charging time duration for the target pixel to be a charging time duration for charging all pixels in the compensation region in which the target pixel is located.

In some embodiments, the second calculating module includes: a first calculating unit, configured to: in a case that the first brightness is greater than the set brightness, the target charging time duration for the target pixel is the set charging time duration for the target pixel minus the compensation time duration for the target pixel; and a second calculating unit, configured to: in a case that the first brightness is less than the set brightness, the target charging time duration for the target pixel is the set charging time duration for the target pixel plus the compensation time duration for the target pixel.

In some embodiments, a difference between a total time duration for charging pixels in all compensation regions before compensation is performed and a total time duration for charging the pixels in the all compensation regions after the compensation is performed is less than a set threshold.

In a fourth aspect, the device for compensating pixel charging is provided in the present disclosure and includes: a charging module, configured to perform charging compensation to pixels in each of at least two compensation regions according to compensation time durations for charging the pixels in the at least two compensation regions, wherein each of the compensation time duration is determined according to the method in the first aspect.

In a fifth aspect, the device for detecting pixel charging compensation is provided in the present disclosure and includes: a processor and a storage, wherein the storage is configured to store a computer program executable on the processor, and when the computer program is executed by the processor, the processor implements steps in the method for detecting pixel charging compensation according to the first aspect.

In a sixth aspect, the device for compensating pixel charging is provided in the present disclosure and includes: a processor and a storage, wherein the storage is configured to store a computer program executable on the processor, and when the computer program is executed by the processor, the processor implements steps of the method for detecting pixel charging compensation according to the second aspect.

In a seventh aspect, a non-transitory computer readable storage medium is provided in the present disclosure and includes: a computer program stored on the computer readable storage medium, wherein when the computer program is executed by a processor, the processor implements steps of the method for detecting pixel charging compensation according to the first aspect.

In an eighth aspect, a non-transitory computer readable storage medium is provided in the present disclosure and includes a computer program stored on the computer readable storage medium, wherein when the computer program is executed by a processor, the processor implements steps of the method for compensating pixel charging according to the second aspect.

In a ninth aspect, a display apparatus is provided in the present disclosure and includes: at least one of the device for detecting pixel charging compensation according to the third aspect, or the device for compensating pixel charging according to the fourth aspect.

### BRIEF DESCRIPTION OF THE DRAWINGS

In order to illustrate technical solutions of some embodiments of the present disclosure more clearly, drawings used in description of some embodiments of the present disclosure will be described hereinafter briefly. Obviously, the drawings merely relate to some embodiments of the present disclosure, and based on these drawings, a person skilled in the art may obtain other drawings without paying any creative effort.

FIG. 1 is a flowchart of a method for detecting pixel charging compensation provided by the present disclosure;

FIG. 2 is a schematic diagram of dividing compensation regions on a display area in the method of FIG. 1;

FIG. 3 is another flowchart of the method for detecting pixel charging compensation provided by the present disclosure;

FIG. 4 is a structural diagram of a device for detecting pixel charging compensation provided by the present disclosure;

FIG. 5 is another structural diagram of the device for detecting pixel charging compensation provided by the present disclosure;

FIG. 6 is a structural diagram of a detecting module in FIG. 4;

FIG. 7 is a structural diagram of a second detecting module in FIG. 5;

FIG. 8 is a flowchart of a method for compensating pixel charging provided by the present disclosure;

FIG. 9 is a structural diagram of a device for compensating pixel charging provided by the present disclosure;

FIG. 10 is still another structural diagram of the device for detecting pixel charging compensation provided by the present disclosure; and

FIG. 11 is another structural diagram of the device for compensating pixel charging provided by the present disclosure.

### DETAILED DESCRIPTION

Technical solutions of some embodiments of the present disclosure will be described hereinafter in a clear and complete manner in conjunction with the drawings of the embodiments. Obviously, the described embodiments merely relate to a part of, rather than all of, the embodiments of the present disclosure. Based on these embodiments of the present disclosure, all other embodiments obtained by a person skilled in the art without paying any creative effort fall within the scope of the present disclosure.

The method for detecting pixel charging compensation, the device for detecting pixel charging compensation, the method for compensating pixel charging, and the device for compensating pixel charging provided by the present disclosure may solve a problem that with a resolution, a pixel density, and a refresh rate of a liquid crystal display panel being continuously improved, charging difference among pixels at different positions increases and the liquid crystal display panel is prone to display a uneven brightness.

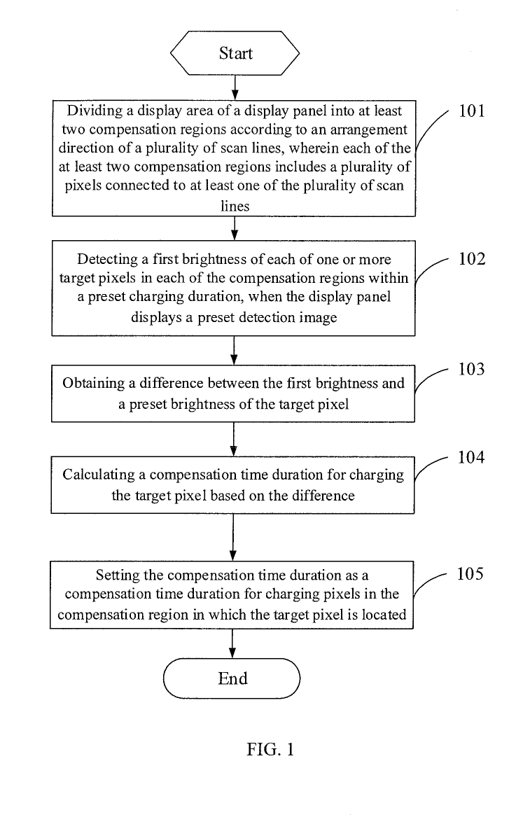

Referring to FIG. 1, FIG. 1 is a flowchart of a method for detecting pixel charging compensation provided in the present disclosure. The method may be performed by the device for detecting pixel charging compensation mentioned below in the present disclosure. As shown in FIG. 1, the method may include following steps 101-105.

Step 101: dividing a display area of a display panel into at least two compensation regions according to an arrangement direction of a plurality of scan lines, wherein each of the at least two compensation regions includes a plurality of pixels connected to at least one of the plurality of scan lines.

In this step, the device for detecting pixel charging compensation may firstly divide the display area of the display panel, and divide the display area into at least two compensation regions according to the arrangement direction of the plurality of scan lines in the display area. Each of the at least two compensation regions includes at least one scan line and includes a plurality of pixels connected to the at least one scan line.

The device for detecting pixel charging compensation may be separated from a display device including the liquid crystal display panel, that is, the device for detecting pixel charging compensation is a third-party detecting device additionally provided outside the display device. The device for detecting pixel charging compensation may also be a same device as the display device, that is, the device for detecting pixel charging compensation may be a detecting portion provided on the display device and used for implementing a detecting function, and is a part of the display device. In other words, the method for detecting pixel charging compensation provided by some embodiments of the present disclosure may be performed by the third-party detecting device additionally provided outside the display device, or may be performed by the display device.

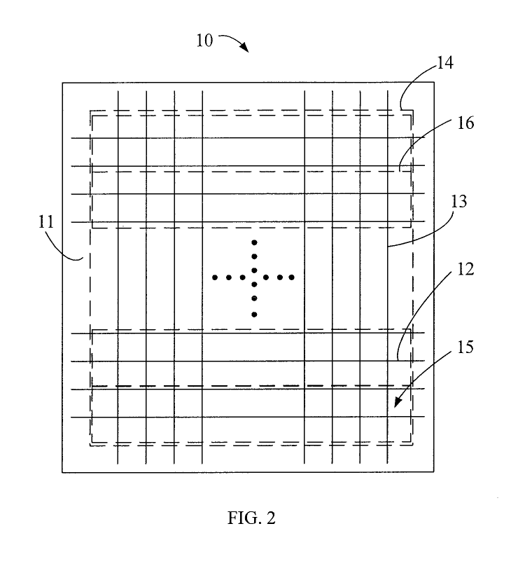

For example, refer to FIG. 2 and FIG. 1, FIG. 2 is a schematic diagram of dividing the compensation regions in a display area according to the method of FIG. 1. A display panel 10 includes a plurality of scan lines 12 and a plurality of data lines 13 on a substrate 11. Each of the plurality of scan lines 12 extends in a first direction, and the plurality of scan lines 12 are arranged in parallel and arranged in the second direction. Each of the plurality of data lines 13 extends in the second direction, and the plurality of data lines 13 are arranged in parallel and arranged in the first direction. In some embodiments, the first direction is a horizontal direction and the second direction is a vertical direction. In other embodiments, the first direction may also be the vertical direction, and the second direction may be the horizontal direction.

An orthographic projection of each of the scan lines 12 on the substrate 11 intersects (e.g., is perpendicular to) orthographic projections of the data lines 13 on the substrate 11, and correspondingly a plurality of pixel areas 15 are formed in a display area 14 of the display panel 10.

In FIG. 2, when dividing the display area 14 into the compensation regions 16, the display area 14 may be divided into at least two compensation regions 16 according to the arrangement direction of the plurality of scan lines 12. That is, in the vertical direction, the display area 14 is divided into the at least two compensation regions 16, such that each of the compensation regions 16 includes at least one scan line 12, and accordingly, each of the compensation regions 16 includes a plurality of pixels connected to the at least one scan line 12. In FIG. 2, description is made by taking, as an example, each of the compensation regions 16 including two scan lines 12.

Step 102: detecting a first brightness of each of one or more target pixels in each of the compensation regions within a preset charging duration, when the display panel displays a preset detection image.

In this step, after the device for detecting pixel charging compensation divides the display area of the display panel into the at least two compensation regions, the device for detecting pixel charging compensation may control the display panel of the display device to implement a display function of the display panel, thereby displaying the preset detection image on the display panel. When displaying the preset detection image, the device for detecting pixel charging compensation may detect a brightness of each of the one or more target pixels in each of the compensation regions, so as to detect the first brightness of each of the one or more target pixels within the preset charging duration, when the preset detection image is displayed.

The detection image may be preset, and may be an image that may easily exhibit a contrast when being displayed, such as an image with different black and white areas or different contrasts. For example, the detection image is a reloaded picture, that is, each of the data lines 13 is required to perform a charging and discharging cycle for each row of pixels.

In one example of the detection image, a brightness of each row of pixels in the detection image is inverted relative to a brightness of another row adjacent to the row of pixels. For example, the brightness of one row of pixels is an intermediate gray level or another gray level sensitive to a charging rate, and the brightness of another row adjacent to the row is a gray level L0 which is the darkest.

In another example of the detection image, the detection image is an image in which bright spots and dark spots are alternated. For example, bright spots and dark spots are alternated in the horizontal direction, and bright spots and dark spots are alternated in the vertical direction (for example, the image exhibits an international chessboard shape). Similarly, the brightness of a bright spot is an intermediate gray level or another gray level sensitive to the charging rate, and the brightness of a dark spot adjacent to the bright spot is the gray level L0 which is the darkest.

The one or more target pixels may be representative pixels configured in each of the compensation regions for purpose of convenient detection, such as pixels located at an intermediate position of the compensation region, or pixels having charging time durations between a longest preset charging time duration and a shortest preset charging time duration in the compensation region.

One or more target pixels may be arranged in each of the compensation regions. A quantity of target pixels in each of the compensation regions may be set according to detection needs, and is not limited. Under a condition that two or more target pixels are arranged in a same compensation region, the two or more target pixels may be pixels connected to different positions of a same scan line, or may be pixels connected to different scan lines. Target pixels in different compensation regions may be pixels connected to a same data line, or may be pixels connected to different data lines.

Step 103: obtaining a difference between the first brightness and a preset brightness of the target pixel.

In this step, after the first brightness of the target pixel is acquired, the device for detecting pixel charging compensation may compare the first brightness with the preset brightness so as to obtain a difference between the first brightness and the preset brightness of the target pixel.

The difference between the first brightness and the preset brightness may be a positive number or a negative number. In actual detection conditions, an absolute value of the difference may be taken, so that a value of the difference is always a positive number and a subsequent calculation operation is facilitated.

Step 104: calculating a compensation time duration for charging the target pixel based on the difference.

Step 105: setting the compensation time duration as a compensation time duration for charging pixels in the compensation region.

In steps 104 and 105, after the device for detecting pixel charging compensation acquires the difference, the device for detecting pixel charging compensation may calculate a charging time duration corresponding to the difference according to a correspondence between a charging brightness and a charging time duration, and thereby obtain a compensation time duration for charging the target pixel, and set the compensation time duration as a compensation time duration for charging pixels in the compensation region in which the target pixel is located. The correspondence between the charging brightness and the charging time duration may be set in advance according to an experiment or other means.

The compensation time duration for charging the pixels in each of the compensation regions may refer to a compensation time duration for charging all the pixels in the compensation region, so that compensation time durations for different compensation regions may be used to improve charging time durations for different compensation regions in the display panel. The entirety of a brightness of the display panel is made to be substantially uniform.

Under a condition that two or more target pixels are configured in the same compensation region, and two or more compensation time durations are obtained, the two or more compensation time durations may be averaged to obtain an average value, and the average value is set to the compensation time duration for charging the pixels in the compensation region.

The method for detecting pixel charging compensation provided by some embodiments of the present disclosure divides a display area into at least two compensation regions according to an arrangement direction of scan lines, wherein each of the compensation regions includes a plurality of pixels connected to at least one scan line, and first brightness values of two or more target pixels in each of the compensation regions within a preset charging time duration are detected when a preset detection image is displayed, and acquires a difference between the first brightness and the preset brightness of each of the target pixels, and calculates a compensation time duration for charging the target pixel based on the difference, and sets the compensation time duration as a compensation time duration for charging pixels in the compensation region. The method divides the display area of the display panel into at least two compensation regions, and detects the first brightness of the target pixel in each of the compensation regions, calculates and determines, according to the difference between the first brightness and the preset brightness, the compensation time duration for charging the pixels in the compensation region in which the target pixel is located. In this way, after the compensation time duration is used to compensate the charging time duration of the pixels in the compensation region, the charging time duration of each of the pixels may be made substantially the same, and differences among charging time durations of pixels at different positions of a signal line due to an increased resolution, an increased pixel density, an increased image refresh rate, and a delay on the signal line are reduced, to ensure that the charging time durations of the pixels at different positions are uniform and sufficiently long, so that the brightness values at different positions on the display area of the display panel are uniform.

Additionally, in the method for detecting pixel charging compensation provided by some embodiments of the present disclosure, since the first brightness of the target pixel is detected in each of the at least two compensation regions, the compensation time duration for charging the target pixel is calculated and determined according to the difference between the first brightness and the preset brightness, and the compensation time duration for charging the target pixel is used as the compensation time duration for charging all pixels in the compensation region in which the target pixel is located, a quantity of pixels, brightnesses of which need to be detected, is reduced, a quantity of pixels, compensation time durations for which need to be calculated is decreased, a calculation volume of a processor is reduced, and a data storage amount of a storage is saved.

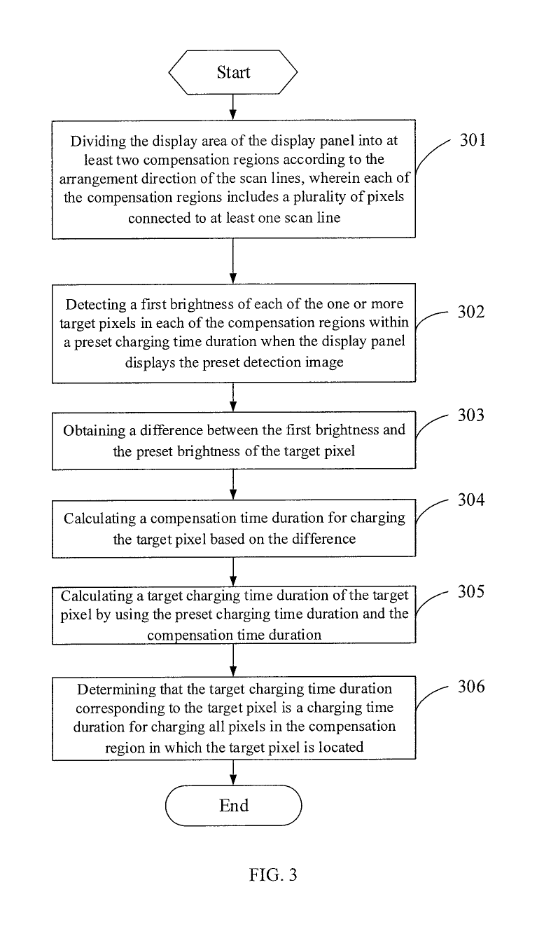

Referring to FIG. 3, FIG. 3 is another flowchart of the method for detecting pixel charging compensation provided by the present disclosure. As shown in FIG. 3, the method for detecting pixel charging compensation includes the following steps 301-306.

Step 301: dividing the display area of the display panel into at least two compensation regions according to the arrangement direction of the scan lines, wherein each of the compensation regions includes a plurality of pixels connected to at least one scan line.

Step 302: detecting a first brightness of each of the one or more target pixels in each of the compensation regions within a preset charging time duration when the display panel displays the preset detection image.

Step 303: obtaining a difference between the first brightness and the preset brightness of the target pixel.

Step 304: calculating a compensation time duration for charging the target pixel based on the difference.

Description of specific implementations of steps 301 to 304 may be obtained by referring to steps 101 to 104.

Step 305: calculating a target charging time duration of the target pixel by using the preset charging time duration and the compensation time duration.

In this step, after the device for detecting pixel charging compensation calculates the compensation time duration for charging the target pixel by using the difference, the device for detecting pixel charging compensation may use the preset charging time duration of the target pixel and the compensation time duration corresponding to the target pixel to calculate the target charging time duration for which the target pixel is charged, according to the compensation time duration of the target pixel.

The target charging time duration may refer to an actual charging time duration required to charge the target pixel in each of the compensation regions after the compensation time duration is used to compensate the preset charging time duration.

Step 306: determining that the target charging time duration corresponding to the target pixel is a charging time duration for charging all pixels in the compensation region in which the target pixel is located.

In this step, after the device for detecting pixel charging compensation obtains the target charging time duration for the target pixel through calculation, the device for detecting pixel charging compensation may determine the target charging time duration of the target pixel, and determine that the target charging time duration corresponding to the target pixel is a total charging time duration for charging all pixels in the compensation region in which the target pixel is located.

In this way, through detecting and calculating, the total charging time duration for charging the pixels in each of the compensation regions after the compensation time duration is determined may be obtained, so that in a subsequent usage process of the display panel, the target charging time duration corresponding to each of the compensation regions may be directly called, so as to charge the pixels in the compensation region in a lump-sum manner.

Optionally, after step 305 and before step 306, the method further includes: calculating an average value of target charging time durations of one or more target pixels, and step 306 may further include determining the average value as a charging time duration for charging all pixels in the compensation region in which the one or more target pixels are located.

Optionally, the step 302 includes: determining one or more key positions in each of the compensation regions when the preset detection image is displayed; and detecting the first brightness of the target pixel in each of the one or more key positions within the preset charging time duration.

In this step, after the device for detecting pixel charging compensation divides the display area of the display panel into at least two compensation regions, the device for detecting pixel charging compensation may control the display panel to display a preset detection image, and when the preset detection image is displayed, one or more key points in each of the compensation regions are detected, and a key position of each of the key points is determined, and thereby the first brightness of the target pixel at the key position within the preset charging time duration is detected.

The key points in each of the compensation regions may be representative points when the preset compensation image is displayed, such as points with obvious contrasts, or points at central positions of the compensation region, or the like. In a case that a quantity of the compensation regions is small, a plurality of key positions along a direction of the data line 13 may be selected to calibrate a charging situation distribution, and thereby how to adjust the charging time duration may be determined. For example, the key positions may be an input end, a center and a distal end of the compensation region, or may be both ends of the compensation region and a plurality of equally spaced positions inside the compensation region.

The first brightness within the preset charging time duration may refer to the first brightness when the detection image is displayed and a charging process for the target pixel is finished.

Optionally, the step of calculating a target charging time duration of the target pixel by using the preset charging time duration and the compensation time duration includes: in a case that the first brightness is greater than the preset brightness, the target charging time duration of the target pixel is the preset charging time duration of the target pixel minus the compensation time duration of the target pixel; and in a case the first brightness is less than the preset brightness, the target charging time duration of the target pixel is the preset charging time duration of the target pixel plus the compensation time duration of the target pixel.

In this step, after the device for detecting pixel charging compensation calculates the compensation time duration of the target pixel by using the difference, and if the device for detecting pixel charging compensation determines that the first brightness is greater than the preset brightness by comparing the first brightness with the preset brightness, then the device for detecting pixel charging compensation may determine that the target charging time duration of the target pixel is the preset charging time duration of the target pixel minus the compensation time duration of the target pixel, and if the device for detecting pixel charging compensation determines that the first brightness is less than the preset brightness by comparing the first brightness with the preset brightness, then the device for detecting pixel charging compensation may determine that the target charging time duration of the target pixel is the preset charging time duration of the target pixel plus the compensation time duration of the target pixel.

Optionally, a difference between a total time duration of charging pixels in all compensation regions before compensation is made and a total time duration of charging the pixels in the all compensation regions after the compensation is made is less than a preset threshold.

In order to ensure parameters such as the image refresh rate of the display panel and a uniformity of an image displayed by the display panel, the charging time duration of the display panel before and after the compensation is made needs to be consistent. Therefore, the charging time duration of all pixels connected to each data line before the compensation is made is approximately equal to the charging time duration of all pixels connected to the data line after the compensation is made, that is, the difference between the charging time duration of all pixels connected to the data line before the compensation is made and the charging time duration of all pixels connected to the data line after the compensation is made is less than the preset threshold, that is, the difference between the total time duration of charging pixels in all compensation regions before the compensation is made and the total time duration of charging pixels in all compensation regions after the compensation is made may be set to be less than the preset threshold.

The method for detecting pixel charging compensation provided by some embodiments of the present disclosure divides a display area into at least two compensation regions according to an arrangement direction of scan lines, wherein each of the compensation regions includes a plurality of pixels connected to at least one of the scan lines; detects a first brightness of each of target pixels in each of the compensation regions within a preset charging time duration when displaying a preset detection image; acquires a difference between the first brightness of the target pixel and a preset brightness; calculates a compensation time duration for charging the target pixel based on the difference; calculates a target charging time duration of the target pixel by using a preset charging time duration and the compensation time duration; determines a target charging time duration corresponding to the target pixel to be the charging time duration for charging all pixels in the compensation region in which the target pixel is located. By dividing the display area of the display panel into at least two compensation regions, and detecting the first brightness of the target pixel in each of the compensation regions, calculating the compensation time duration for charging the target pixel according to the difference between the first brightness and the preset brightness, and based on the compensation time duration and the preset charging time duration, the target charging time duration for charging the target pixel after the compensation is made may be obtained by calculation. In this way, after the obtained compensation time duration is used to compensate for the charging time duration of the pixels in the compensation region, charging time durations of all pixels in the display panel may be made to be substantially equal, the charging difference among pixels at different positions of the display panel due to at least one of the improved resolution, the improved pixel density, the improved image refresh rate, or the delay of a signal line is reduced, and a charging uniformity among pixels at different positions of the display panel is ensured and a charging time duration for the pixels is sufficient and thus the brightness of pixels at different positions in the display area of the display panel is kept to be uniform.

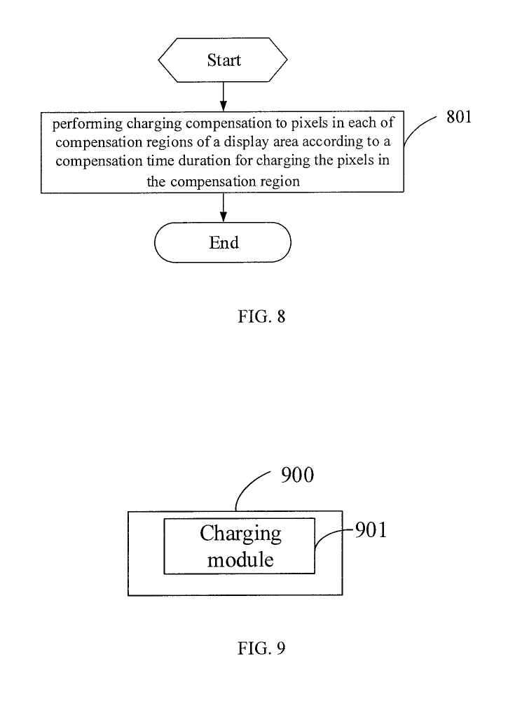

Some embodiments of the present disclosure also provide a method for compensating pixel charging. Referring to FIG. 8, the method for compensating pixel charging includes a step 801.

Step 801: performing charging compensation to pixels in each of compensation regions of a display area according to a compensation time duration for charging the pixels in the compensation region, wherein the compensation time duration is determined according to the method for detecting pixel charging compensation in FIGS. 1 to 2.

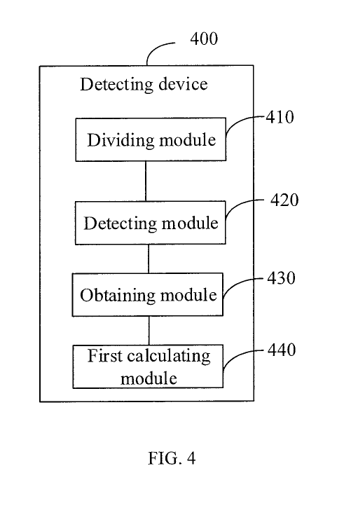

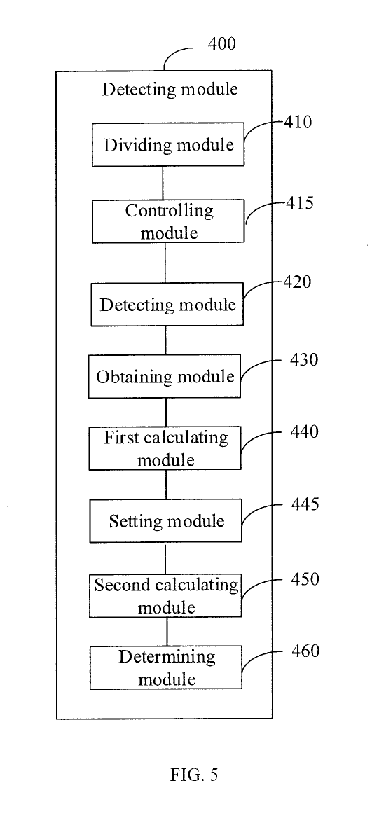

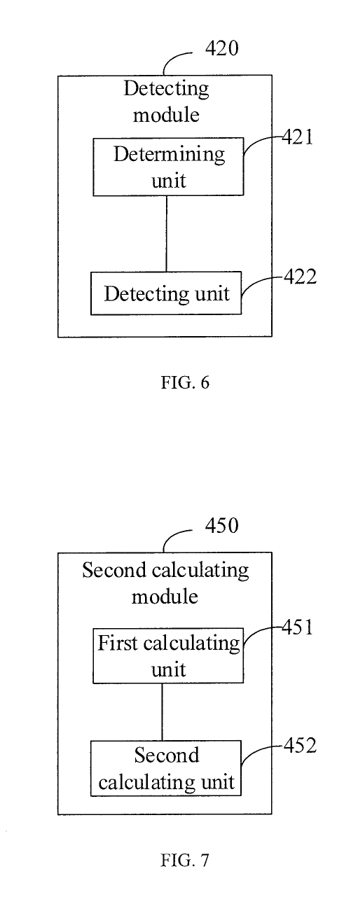

Referring to FIG. 4 to FIG. 7. FIG. 4 is a structural diagram of a device for detecting pixel charging compensation provided in the present disclosure. FIG. 5 is another structural diagram of the device for detecting pixel charging compensation provided in the present disclosure, and FIG. 6 is the structural diagram of a detection module shown in FIG. 4, and FIG. 7 is a structural diagram of a second detection module shown in FIG. 5. The device for detecting pixel charging compensation herein may implement the method for detecting pixel charging compensation provided above in the present disclosure.

As shown in FIG. 4 to FIG. 7, the device for detecting pixel charging compensation 400 includes: a dividing module 410, configured to divide a display area of a display panel into at least two compensation regions according to an arrangement direction of a plurality of scan lines, wherein a plurality of pixels connected to at least one of the plurality of scan lines are arranged in each of the compensation regions; a detecting module 420, configured to detect a first brightness of each of one or more target pixels in each of the compensation regions within a preset charging time duration when a preset detection image is displayed in the display panel; an obtaining module 430, configured to obtain a difference between the first brightness and a preset brightness of the target pixel; and a first calculating module 440, configured to calculate a compensation time duration for charging the target pixel based on the difference.

Optionally, the device for detecting pixel charging compensation 400 may further include: a setting module 445, configured to set the compensation time duration of the target pixel as a compensation time duration for charging pixels in the compensation region in which the target pixel is located.

Optionally, the detecting module 420 includes: a determination unit 421, configured to determine one or more key positions in each of the compensation regions when the preset detection image is displayed in the display panel; and a detecting unit 422, configured to detect a first brightness of a target pixel at each of the one or more key locations within the preset charging time duration.

Optionally, the device for detecting pixel charging compensation 400 includes: a controlling module 415, configured to control the display panel to display the preset detection image.

Optionally, the device for detecting pixel charging compensation 400 includes: a second calculating module 450, configured to calculate a target charging time duration for the target pixel by using the preset charging time duration and the compensation time duration; and a determining module 460, configured to determine the target charging time duration for the target pixel as a charging time duration for charging all pixels in the compensation region in which the target pixel is located.

Optionally, the second calculating module 450 includes: a first calculating unit 451, configured to: in a case that the first brightness is greater than the preset brightness, set a target charging time duration of the target pixel to be the preset charging time duration of the target pixel minus the compensation time duration of the target pixel; and the second calculating unit 452, configured to: in a case that the first brightness is less than the preset brightness, set the target charging time duration of the target pixel to be the preset charging time duration of the target pixel plus the compensation time duration of the target pixel.

Optionally, a difference between a total time duration for charging pixels in all of the compensation regions before compensation is made and a total time duration for charging pixels in all of the compensation regions after the compensation is made is less than a preset threshold.

The device for detecting pixel charging compensation 400 provided by the present disclosure may implement various processes implemented by the method of FIG. 1 to FIG. 2, and details of the processes are not described herein again to avoid repetition.

The device for detecting pixel charging compensation according to some embodiments of the present disclosure divides a display area of a display panel into at least two compensation regions according to an arrangement direction of scan lines, wherein each of the compensation regions includes a plurality of pixels connected to at least one of the scan lines; detects a first brightness of each of one or more target pixels in each of the compensation regions within a preset charging time duration when the display panel displays a preset detection image; acquires a difference between a first brightness of the target pixel and the preset brightness; calculates a compensation time duration for charging the target pixel based on the difference. By dividing the display area of the display panel into at least two compensation regions, and detecting the first brightness of the target pixel in each of the compensation regions, calculating a compensation time duration for charging the target pixel according to the difference between the first brightness and the preset brightness. In this way, after compensating the charging time duration of the pixels in the compensation region by using the calculated compensation time duration, the charging time durations of the pixels may be made to be substantially equal, and the charging differences among the pixels at different positions of a signal line due to the improved resolution, the improved pixel density, the improved refresh rate, and the delay of the signal line may be reduced, the charging uniformity of the pixels at different positions is ensured and the charging time duration for the pixels is sufficient, so that the brightness values of pixels at different positions on the display area of the display panel are uniform.

Additionally, in the device for detecting pixel charging compensation provided by some embodiments of the present disclosure, since the first brightness of the target pixel is detected in each of the at least two compensation regions, the compensation time duration for charging the target pixel is calculated and determined according to the difference between the first brightness and the preset brightness, and the compensation time duration for charging the target pixel is used as the compensation time duration for charging all pixels in the compensation region in which the target pixel is located, a quantity of pixels, brightnesses of which need to be detected, is reduced, a quantity of pixels, compensation time durations for which need to be calculated is decreased, a calculation volume of a processor is reduced, and a data storage amount of a storage is saved.

Some embodiments of the present disclosure also provide a device for compensating pixel charging. Referring to FIG. 9, the device for compensating pixel charging 900 may be applied to a display panel. The device for compensating pixel charging 900 includes: a charging module 901, configured to perform charging compensation to pixels in each of the compensation regions according to a compensation time duration for charging pixels in the compensation region. The compensation time duration is determined according to the method for detecting the pixel charging compensation in the FIGS. 1 to 2.

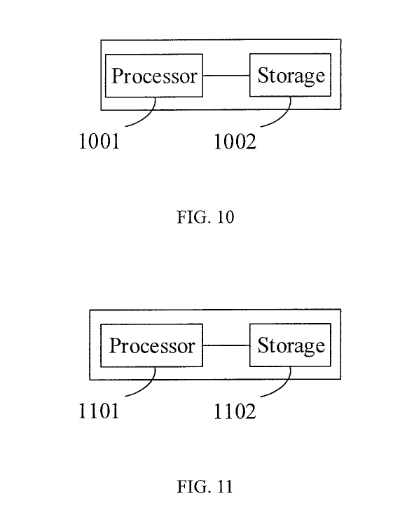

In some embodiments of the present disclosure, the present disclosure further provides a device for detecting pixel charging compensation. Referring to FIG. 10, the device for detecting pixel charging compensation includes a storage 1001 and a processor 1002, wherein the storage 1001 stores a computer program executable on the processor 1002, and when the computer program is executed by the processor 1002, the processor 1002 executes respective steps of the method for detecting pixel charging compensation shown in FIG. 1 or FIG. 2 and may achieve same technical effects.

In some embodiments of the present disclosure, the present disclosure further provides a device for compensating pixel charging. Referring to FIG. 11, the device for compensating pixel charging includes a storage 1101 and a processor 1102, wherein the storage 1101 stores a computer program executable on the processor 1102, and the processor 1102 implements following steps when the computer program is executed by the processor 1102: performing charging compensation for pixels in each of compensation regions of a display area according to a compensation time duration for charging pixels in the compensation region, wherein the compensation time duration is determined according to the method for detecting pixel charging compensation in FIG. 1 to FIG. 2.

Additionally, in the device for compensating pixel charging provided by some embodiments of the present disclosure, since the first brightness of the target pixel is detected in each of the at least two compensation regions, the compensation time duration for charging the target pixel is calculated and determined according to the difference between the first brightness and the preset brightness, and the compensation time duration for charging the target pixel is used as the compensation time duration for charging all pixels in the compensation region in which the target pixel is located, a quantity of pixels, brightnesses of which need to be detected, is reduced, a quantity of pixels, compensation time durations for which need to be calculated is decreased, a calculation volume of a processor is reduced, and a data storage amount of a storage is saved.

In some embodiments of the present disclosure, the present disclosure further provides a display device. The display device includes at least one of the device for detecting pixel charging compensation or the device for compensating pixel charging provided by the above embodiments of the present disclosure.

A person skilled in the art may appreciate that units, algorithms, and steps of various examples described in connection with the embodiments disclosed herein, such as the steps of the method for detecting pixel charging compensation illustrated in FIG. 1 or FIG. 2, and the method for compensating pixel charging shown in FIG. 8, the modules or the units of the device for detecting pixel charging compensation shown in FIG. 4 to FIG. 7. and the modules or the units of the device for compensating pixel charging shown in FIG. 9 may be implemented by electronic hardware (such as electronic circuits, integrated circuits, System-On-Chip, FPGA, microcontroller, etc.), or a combination of computer software and electronic hardware. Whether these functions are performed in hardware or software depends on a specific application and design constraints of the solutions. A person skilled in the art may use different methods to implement the described functions for each particular application, but such implementation should not be considered to go beyond the scope of the present disclosure.

The present disclosure also provides a computer readable storage medium, wherein the computer readable storage medium stores a computer program thereon, and when the computer program is executed by a processor, the processor implements the steps of the method for detecting pixel charging compensation shown in FIG. 1 or FIG. 3 or the steps of the method for compensating pixel charging shown in FIG. 8, and may achieve the same technical effect. The computer readable storage medium may be volatile or non-volatile, such as a Read-Only Memory (ROM), a Random Access Memory (RAM), a magnet disk or a compact disc.

A person skilled in the art may clearly understand that for sake of convenience and brevity in description, specific working processes of the system, the device and the unit described above may refer to corresponding processes in the foregoing process embodiments, and details are not described herein again.

In the embodiments provided by the present application, it should be understood that the disclosed apparatus, device and method may be implemented in other manners. For example, the product embodiments described above are merely illustrative. For example, divisions of units are only logical function divisions. In actual implementations, there may be another division manner, for example, multiple units or components may be combined or may be integrated into another system, or some features may be ignored or not executed. In addition, coupling or direct coupling or communication connection shown or discussed herein may be an indirect coupling or communication connection through some interface, device or unit, and may be electrical, mechanical or other forms.

The units described as separate components may or may not be physically separated, and the components shown as units may or may not be physical units, that is, may be located in one place, or may be distributed to multiple network units. Some or all of the units may be selected according to actual needs to achieve the objectives of some embodiments of the present disclosure.

In addition, the methods or functional units in various embodiments of the present disclosure may be integrated into one processing unit, and each of the units may exist physically separately, or two or more units may be integrated into one unit.

The method or function, if being implemented in a form of a software functional unit and sold or used as a standalone product, may be stored in a computer readable storage medium. The computer readable storage medium may be volatile or non-volatile. Based on such understanding, an essential portion of the technical solution of the present disclosure or a portion of the technical solution that contributes to the related art or a part of the technical solution may be embodied in a form of a software product stored in a storage medium, wherein the storage medium includes instructions for causing a computer device (which may be a personal computer, a server, or a network device, etc.) to perform all or part of the steps of the methods described in various embodiments of the present disclosure. The foregoing storage medium includes various media that may store program and codes, such as a USB flash drive, a mobile hard disk, a ROM, a RAM, a magnetic disk, or an optical disk.

The display panel mentioned in the present disclosure may be any type of flat panel display panel including, but not limited to, LCD display panels, LED display panels, OLED display panels, AMOLED display panels, and the like.

The above are only specific embodiments of the present disclosure, but the scope of the present disclosure is not limited thereto, and any person skilled in the art may easily think of changes or substitutions within the technical scope of the disclosure and the changes or substitutions also fall within the protection scope of the present disclosure. Therefore, the protection scope of the disclosure should be determined by the scope of the claims.

1. A method for detecting pixel charging compensation, comprising:
dividing a display area of a display panel into at least two compensation regions according to an arrangement direction of a plurality of scan lines, wherein each of the at least two compensation regions comprises a plurality of pixels connected to at least one of the plurality of scan lines;
detecting a first brightness of each target pixel of one or more target pixels in each of the plurality of compensation regions within a set charging time duration when the display panel displays a set detection image;
obtaining a difference between the first brightness and a set brightness of the target pixel;
calculating a compensation time duration for charging the target pixel based on the difference; and
setting the compensation time duration to be a compensation time duration for charging pixels in the compensation region in which the target pixel is located.

2. The method according to claim 1, wherein the detecting the first brightness of the each target pixel of the one or more target pixels in each of the plurality of compensation regions within the set charging time duration when the display panel displays the set detection image, comprises:
determining one or more key positions in each of the plurality of compensation regions when the display panel displays the set detection image; and
detecting the first brightness of the target pixel at each of the one or more key locations within the set charging time duration.

3. The method according to claim 1, wherein after calculating the compensation time duration for charging the target pixel based on the difference, the method further comprises:
calculating a target charging time duration for the target pixel by using the set charging time duration and the compensation time duration;
determining the target charging time duration for the target pixel to be the charging time duration for charging all pixels in the compensation region in which the target pixel is located.

4. The method according to claim 3, wherein the calculating the target charging time duration for the target pixel by using the set charging time duration and the compensation time duration, comprises:
in a case that the first brightness is greater than the set brightness, the target charging time duration for the target pixel is the set charging time duration of the target pixel minus the compensation time duration for the target pixel; and
in a case that the first brightness is less than the set brightness, the target charging time duration for the target pixel is the set charging time duration for the target pixel plus the compensation time duration for the target pixel.

5. The method according to claim 1, wherein a difference between a total time duration for charging pixels in all compensation regions before compensation is performed and a total time duration for charging the pixels in the all compensation regions after the compensation performed is less than a set threshold.

6. The method according to claim 1, wherein the one or more target pixels are pixels located at in-between positions of the compensation region, or pixels for which a charging time duration is between a longest set charging time duration and a shortest set charging time duration in the compensation region.

7. The method according to claim 1, wherein a quantity of the target pixels is two or more than two, and the compensation time duration for charging the pixels in each of the plurality of compensation regions is an average value of compensation time durations calculated according to differences of the two or more than two target pixels.

8. The method according to claim 1, wherein the first brightness is a brightness when the display panel displays the detection image and a charging process for the target pixel is finished.

9. A method for compensating pixel charging, comprising:
performing charging compensation to pixels in a compensation region based on a compensation time duration for charging the pixels in the compensation region, wherein the compensation time duration is determined according to the method of claim 1.

10. A device for detecting pixel charging compensation, comprising:
a dividing circuit, configured to divide a display area of a display panel into at least two compensation regions according to an arrangement direction of a plurality of scan lines, wherein each of the plurality of compensation regions comprises a plurality of pixels connected to at least one of the plurality of scan lines;
a detecting circuit, configured to detect a first brightness of each of one or more target pixels in each of the plurality of compensation regions within a set charging time duration when the display panel displays the set detection image;
an obtaining circuit, configured to obtain a difference between the first brightness and a set brightness of the target pixel;
a first calculating circuit, configured to calculate a compensation time duration for charging the target pixel based on the difference; and
a setting circuit, configured to set the compensation time duration to be a compensation time duration for charging pixels in the compensation region in which the target pixel is located.

11. The device according to claim 10, wherein the detecting circuit comprises:
a determining sub-circuit, configured to determine one or more key positions in each of the plurality of compensation regions when the display panel displays the set detection image; and
a detecting sub-circuit, configured to detect the first brightness of the target pixel at each of the one or more key positions within the set charging time duration.

12. The device according to claim 10, further comprising:
a second calculating circuit, configured to calculate a target charging time duration for the target pixel by using the set charging time duration and the compensation time duration; and
a determining circuit, configured to determine the target charging time duration for the target pixel to be a charging time duration for charging all pixels in the compensation region in which the target pixel is located.

13. The device according to claim 12, wherein the second calculating circuit comprises:
a first calculating sub-circuit, configured to: in a case that the first brightness is greater than the set brightness, the target charging time duration for the target pixel is the set charging time duration for the target pixel minus the compensation time duration for the target pixel; and
a second calculating sub-circuit, configured to: in a case that the first brightness is less than the set brightness, the target charging time duration for the target pixel is the set charging time duration for the target pixel plus the compensation time duration for the target pixel.

14. The device according to claim 10, wherein a difference between a total time duration for charging pixels in all compensation regions before compensation is performed and a total time duration for charging the pixels in the all compensation regions after the compensation is performed is less than a set threshold.

15. A device for compensating pixel charging, comprising:
a charging circuit, configured to perform charging compensation to pixels in each of at least two compensation regions according to compensation time durations for charging the pixels in the at least two compensation regions, wherein each of the compensation time duration is determined according to the method of claim 1.

16. A device for detecting pixel charging compensation, comprising:
a processor and a storage, wherein the storage is configured to store a computer program executable on the processor, and when the computer program is executed by the processor, the processor implements steps in the method for detecting pixel charging compensation according to claim 1.

17. A device for compensating pixel charging, comprising:
a processor and a storage, wherein the storage is configured to store a computer program executable on the processor, and when the computer program is executed by the processor, the processor implements steps of the method for detecting compensating pixel charging according to claim 9.

18. (canceled)

19. (canceled)

20. A display apparatus, comprising:
the device for detecting pixel charging compensation according to claim 10.

21. A display apparatus, comprising:
the device for compensating pixel charging according to claim 15.
